(19) United States
(12) Patent Application Publication
(10) Pub. No.: US 2013/0169444 A1
(43) Pub. Date: Jul. 4, 2013

(54) SERVER SYSTEM

(71) Applicants: KANG WU, Shenzhen City (CN); BO TIAN, Shenzhen City (CN)

(72) Inventors: KANG WU, Shenzhen City (CN); BO TIAN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/400,763

(22) Filed: Feb. 21, 2012

(30) Foreign Application Priority Data
Dec. 30, 2011 (CN) 201110451917.X

(51) Int. Cl. G08B 21/00

(52) U.S. Cl. 340/635

(57) ABSTRACT

A server system includes an enclosure, first to fourth subsystems, first to third AND gates, and an indicator. The indicator is mounted on a front panel of the enclosure. The first and second subsystems are respectively connected to two input terminals of the first AND gate. The third and fourth subsystems are respectively connected to two input terminals of the second AND gate. Output terminals of the first and second AND gates are respectively connected to two input terminals of the third AND gate. An output terminal of the third AND gate is connected to the indicator. When any one or more of the first to fourth subsystems breaks down, the indicator is started.

### BACKGROUND

1. Technical Field

The present disclosure relates to a server system.

2. Description of Related Art

In a server system, a plurality of subsystems are mounted in an enclosure of the server system. The subsystems communicate with other devices, such as hard disk drives, of the server system through a backplane of the server system. Some indicator lights are mounted on the backplane to indicate the status of corresponding subsystems. However, because the backplane is located at the back of the enclosure, it is inconvenient for users to observe the indicator lights.

### BRIEF DESCRIPTION OF THE DRAWINGS

Many aspects of the present embodiments can be better understood with reference to the following drawings. The components in the drawing are not necessarily drawn to scale, the emphasis instead being placed upon clearly illustrating the principles of the present disclosure. Moreover, in the drawings, all the views are schematic, and like reference numerals designate corresponding parts throughout the several views.

FIG. 1 is a schematic view of an exemplary embodiment of a server system, wherein the server system includes a detection system.

FIG. 2 is a circuit diagram of the detection system of FIG. 1.

### DETAILED DESCRIPTION

The disclosure, including the accompanying drawings in which like references indicate similar elements, is illustrated by way of example and not by way of limitation. It should be noted that references to “an” or “one” embodiment in this disclosure are not necessarily to the same embodiment, and such references mean at least one.

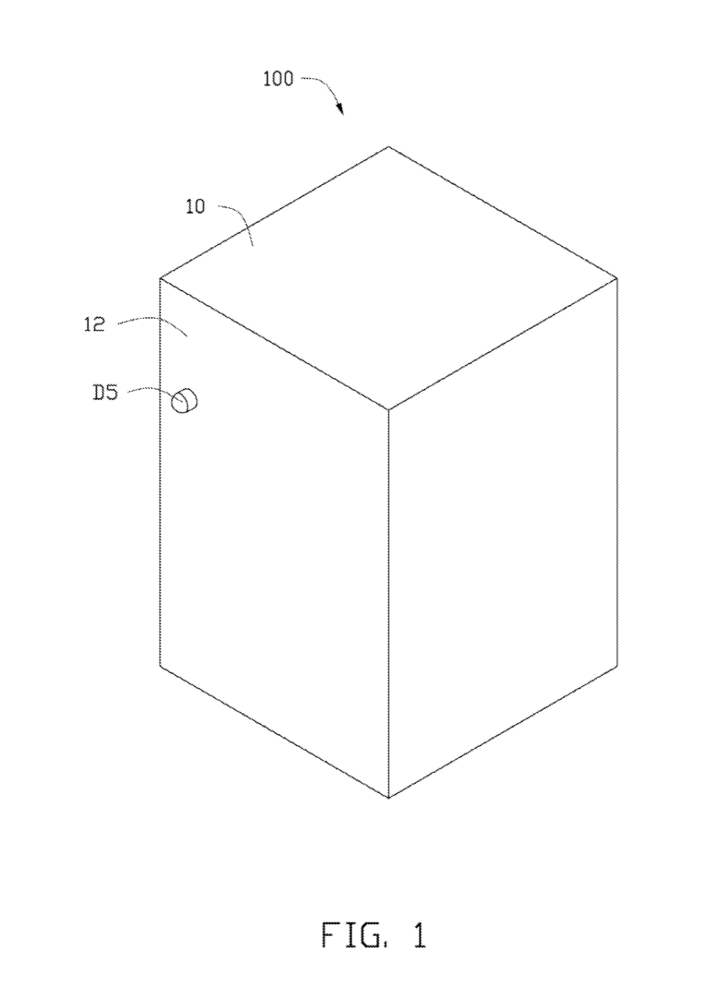

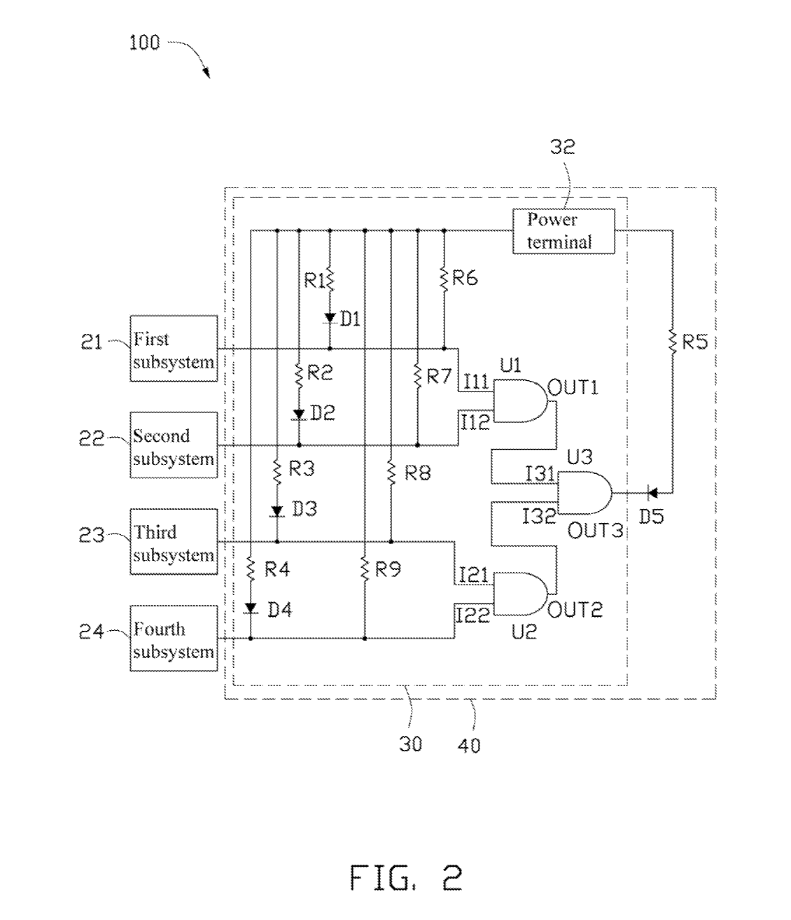

Referring to the FIGS. 1 and 2, an embodiment of a server system 100 includes an enclosure 10, first to fourth subsystems 21-24, and a detection system 40.

The detection system 40 includes a first AND gate U1, a second AND gate U2, a third AND gate U3, resistors R1-R9, and first to fifth indicators, such as first to fifth light emitting diodes (LEDs) D1-D5.

The first to third AND gates U1-U3, the first to fourth LEDs D1-D4, and the resistors R1-R4, and R6-R9 are mounted on a backplane 30 of the server system 100. The fifth LED D5 is mounted on a front panel 12 of the enclosure 10. The first to fourth subsystems 21-24 are connected to the backplane 30 to communicate with other devices, such as hard disk drives, of the server system 100 through the backplane 30.

A first input terminal I11 of the first AND gate U1 is connected to the first subsystem 21 to receive a first state signal from the first subsystem 21. The first input terminal I11 of the first AND gate U1 is also connected to a cathode of the first LED D1, and connected to a power terminal 32 of the backplane 30 through the resistor R6. An anode of the first LED D1 is connected to the power terminal 32 through the resistor R1. A second input terminal I12 of the first AND gate U1 is connected to the second subsystem 22 to receive a second state signal from the second subsystem 22. The second input terminal I12 of the first AND gate U1 is also connected to a cathode of the second LED D2, and connected to the power terminal 32 through the resistor R7. An anode of the second LED D2 is connected to the power terminal 32 through the resistor R2.

A first input terminal I21 of the second AND gate U2 is connected to the third subsystem 23 to receive a third state signal from the third subsystem 23. The first input terminal I21 of the second AND gate U2 is also connected to a cathode of the third LED D3, and connected to the power terminal 32 through the resistor R8. An anode of the third LED D3 is connected to the power terminal 32 through the resistor R3. A second input terminal I22 of the second AND gate U2 is connected to the fourth subsystem 24 to receive a fourth state signal from the fourth subsystem 24. The second input terminal I22 of the second AND gate U2 is also connected to a cathode of the fourth LED D4, and connected to the power terminal 32 through the resistor R9. An anode of the fourth LED D4 is connected to the power terminal 32 through the resistor R4.

A first input terminal I31 of the third AND gate U3 is connected to an output terminal OUT1 of the first AND gate U1. A second input terminal I32 of the third AND gate U3 is connected to an output terminal OUT2 of the second AND gate U2. An output terminal OUT3 of the third AND gate U3 is connected to a cathode of the fifth LED D5. An anode of the fifth LED D5 is connected to the power terminal 32 through the resistor R5.

When any one or more of the first to fourth subsystems 21-24 break down, the broke down subsystem/s each output a low level signal, such as a logic 0 signal. When the first to fourth subsystems 21-24 all operate normally, the first to fourth subsystems 21-24 each output a high level signal. Therefore, when any one or more of the first to fourth subsystems 21-24 breaks down, low level signal/s is outputted to the corresponding AND gate and the corresponding LED, thus the output terminal OUT3 of the third AND gate U3 outputs a low level signal to light the fifth LED D5.

An example to describe a working principle of the detection system 40 follows.

For example, the first subsystem 21 breaks down, and the second to fourth subsystems 22-24 operate normally. The first subsystem 21 outputs a low level signal to the cathode of the first LED D1 and the first input terminal I11 of the first AND gate U1. The second subsystem 22 outputs a high level signal to the cathode of the second LED D2 and the second input terminal I12 of the first AND gate U1. The third subsystem 23 outputs a high level signal to the cathode of the third LED D3 and the first input terminal I21 of the second AND gate U2. The fourth subsystem 24 outputs a high level signal to the cathode of the fourth LED D4 and the second input terminal I22 of the second AND gate U2. The first LED D1 emits light to indicate that the first subsystem 21 has broken down. The second to fourth LED D2-D4 remain off. According to work property of the AND gate, the output terminal OUT1 of the first AND gate U1 outputs a low level signal to the first input terminal I31 of the third AND gate U3. The output terminal OUT2 of the second AND gate U2 outputs a high level signal to the second input terminal I32 of the third AND gate U3. The output terminal OUT3 of the third AND gate U3 outputs a low level signal to the fifth LED D5. The fifth LED D5 emits light to indicate that at least one of the first to fourth subsystems 21-24 has broken down.

If the first to fourth subsystems 21-24 operate normally, the first to fourth LEDs D1-D4 remain off. The first to third AND gates U1-U3 each output a high level signal. The fifth LED D5 remains off indicating that the first to fourth subsystems 21-24 operate normally.

Although numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. A server system comprising:
an enclosure comprising a front panel;
first to fourth subsystems to output first to fourth state signals; and
a detection system comprising:
a first AND gate comprising a first input terminal connected to the first subsystem to receive the first state signal, a second input terminal connected to the second subsystem to receive the second state signal, and an output terminal;
a second AND gate comprising a first input terminal connected to the third subsystem to the receive the third state signal, a second input terminal connected to the fourth subsystem to receive the fourth state signal, and an output terminal; and
a third AND gate comprising a first input terminal connected to the output terminal of the first AND gate, a second input terminal connected to the output terminal of the second AND gate, and an output terminal; and
a first indicator connected to the output terminal of the third AND gate, and mounted on the front panel of the enclosure;
wherein when any one or more of the first to fourth subsystems breaks down, the first indicator is started.

2. The server system of claim 1, further comprising a backplane, wherein the first to third AND gates are mounted on the backplane.

3. The server system of claim 2, wherein the detection system further comprises second to fifth indicators, the second to fifth indicators are mounted on the backplane, the second indicator is connected to the first subsystem to receive the first state signal, the third indicator is connected to the second subsystem to receive the second state signal, the fourth indicator is connected to the third subsystem to receive the third state signal, the fifth indicator is connected to the fourth subsystem to receive the fourth state signal, wherein when any one or more of the first to fourth subsystems breaks down, the corresponding indicator is started.

4. The server system of claim 3, wherein the first to fifth indicators are respectively first to fifth light emitting diodes (LEDs).

5. The server system of claim 4, wherein a cathode of the first LED is connected to the output terminal of the third AND gate, an anode of the first LED is connected to a power terminal of the backplane, a cathode of the second LED is connected to the first subsystem to receive the first state signal, an anode of the second LED is connected to the power terminal of the backplane, a cathode of the third LED is connected to the second subsystem to receive the second state signal, an anode of the third LED is connected to the power terminal of the backplane, a cathode of the fourth LED is connected to the third subsystem to receive the third state signal, an anode of the fourth LED is connected to the power terminal of the backplane, a cathode of the fifth LED is connected to the fourth subsystem to receive the fourth state signal, an anode of the fifth LED is connected to the power terminal of the backplane.

6. The server system of claim 5, wherein the detection system further comprises first to fifth resistors, the anode of the first LED is connected to the power terminal of the backplane through the first resistor, the anode of the second LED is connected to the power terminal of the backplane through the second resistor, the anode of the third LED is connected to the power terminal of the backplane through the third resistor, the anode of the fourth LED is connected to the power terminal of the backplane through the fourth resistor, the anode of the fifth LED is connected to the power terminal of the backplane through the fifth resistor.

7. The server system of claim 2, wherein the detection system further comprises sixth to ninth resistors, the first input terminal of the first AND gate is connected to a power terminal of the backplane through the sixth resistor, the second input terminal of the first AND gate is connected to the power terminal of the backplane through the seventh resistor, the first input terminal of the second AND gate is connected to the power terminal of the backplane through the eighth resistor, the second input terminal of the second AND gate is connected to the power terminal of the backplane through the ninth resistor.
